(19) United States
(12) Patent Application Publication
(10) Pub. No.: US 2008/0145071 A1
(43) Pub. Date: Jun. 19, 2008

(54) Image forming apparatus, image forming method, and computer readable storage medium storing image forming program

(75) Inventor: Kenji Ogasawara, Kawaguchi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/907,284

(22) Filed: Oct. 10, 2007

(30) Foreign Application Priority Data
Dec. 15, 2006 (JP) 2006-339073

(51) Int. Cl. G03G 15/01

(52) U.S. Cl. 399/28

(57) ABSTRACT

An image forming apparatus having a determining unit that analyzes data concerning an image to be printed and determines the order of overlaying toners of in a plurality of colors to be used for printing the particular image, and a designating unit that designates positions of the toner cartridges in accordance with the order of overlaying the toners determined by the abovementioned determining unit.

### CROSS-REFERENCE TO RELATED APPLICATION

This application is based on Japanese Patent Application No. 2006-339073, filed on Dec. 15, 2006, the contents of which are incorporated herein by reference.

### BACKGROUND

1. Technical Field

The present invention pertains to an image forming apparatus, an image forming method, and a computer program for fairly printing spot colors in an image forming process where spot color toners are used in addition to the standard color toners such as CMYK, CMY, and CM.

2. Description of Related Art

It is always a requirement to produce high quality images in an image forming apparatus such as a printer and an MFP (Multi Function Peripheral). It is also a requirement to achieve such high printing quality for the images including spot colors such as metallic colors, corporate colors, and pastel colors, in a user-friendly manner.

In an image forming apparatus such as an MFP and a printer, color images are normally formed by applying, in sequence, toners in the four colors: C (cyan), M (magenta), Y (yellow), and K (black). Therefore, four processing units corresponding to these four toners are provided in each image forming apparatus. It is necessary to add a fifth processing unit in order to make it possible to print images including spot colors as well, in addition to CMYK. For that purpose, it is necessary to redesign mechanical structural parts such as a cabinet and a transport passage, etc., which costs a substantial amount of development cost, resulting in an increase in the product price. In order to enable color printing using more than two spot colors, it requires additional mechanical structure changes.

One way to avoid such inconveniences is to modify one of the CMYK process units into the one for a spot color. This involves use of either an existing process cartridge which structurally integrate all of the individual process units, or an existing toner cartridge which composed of a developing unit for each of the process units (Both of them may be called hereinafter simply as a toner cartridge generically), by replacing one of the CMYK toner cartridges with a spot color toner cartridge in the same size and shape. However, such mere replacement of CMYK cartridges with a spot color cartridge won't allow for controlling the order of applying toners so that printing property of each spot can be utilized, and this may cause difficulty in obtaining such fair output images as designers would intend.

For example, in the case of printing an image including color gradation from a thick red spot color (S2) to yellow (Y), and further gradation from there to gold spot color (S1) (assuming an images intended to express, by gradation, a red-colored merchandise being irradiated by a streak of light for shining in the reflected light), its output won't be as fair as intended unless toners are applied in the order of yellow (Y), gold spot color (S1), and thick red spot color (S2) due to printing properties of these spot colors.

A simple method has been known for printing with spot colors on a thermal transfer-printer wherein ink cartridges wrapped with conventional CMYK printing dye ink paper are taken out to be replaced with ink cartridges wrapped with spot ink paper of silver, gold, and the like to overcoat CMYK images. See Japanese Unexamined Patent Publication No. 11-70680.

However, the thermal transfer-printer described above simply uses spot color ink cartridges in place of CMYK ink cartridges, and therefore the order of applying the toners has to be a predetermined order, irrespective of printing properties of the spot colors.

On the contrary, in the electronic photograph method, a toner image in various colors is prepared by applying toners for various colors like CMYK and spot colors in sequence, and the prepared toner image in the various colors is transferred to recording paper all at once in order to be fixed thereon. Consequently, this method is distinctive in that the arrangement of the toner cartridges for the CMYK and spot colors is significant in determining the order of applying toners. As a result, this method causes in some cases difficulty in achieving such fair output images as designers would intends.

### SUMMARY

It is an object of the present invention to provide an image forming apparatus, an image forming method, and a computer readable storage medium for an image forming program, which can form a toner image in CMYK and spot colors by overlaying the toners for the CMYK and spot colors in such order as an user intends.

To achieve at least one of the abovementioned objects, an image forming apparatus reflecting an aspect of the present invention comprises a determining unit and a designating unit. The determining unit analyses data concerning an image to be printed, and determines the order of overlaying toners in a plurality of colors to be used for the particular image. The designating unit designates positions of the toner cartridges in accordance with the order of overlaying the toners determined by the designating unit.

It is preferable in the abovementioned image forming apparatus that the toners for the plurality of colors to be used for printing the image includes two or more of toners (1) for the standard colors, i.e., C (cyan), M (magenta), Y (yellow), and K (black), and (2) at least one spot color.

It is preferable that the determining unit in the image forming apparatus determines the order of overlaying the toners in accordance with descending order of brightness of the toners.

It is also preferable that the determining unit in the image forming apparatus determines the order of overlaying the toners in accordance with users' specification.

It is preferable that the image forming apparatus has a notifying unit for notifying the user, in the case where the number of colors to be used exceeds the maximum number of cartridges that can be contained in a toner cartridge storage compartment, that used toner cartridges should be replaced with toner cartridges after the image formation in the same number of colors as said maximum number, for the image formation in the remaining colors, in accordance with the order of overlaying toners determined by the determining unit.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating the overall construction of a printing system according to an embodiment of the present invention.

FIG. 2 is a block diagram illustrating the construction of the MFP shown in FIG. 1.

FIG. 3 is a block diagram illustrating the structure of the MFP.

FIG. 4 is a diagram showing a toner attribute administration table.

FIG. 5 is a diagram showing an example of the correlation of typical brightness.

FIG. 6 is a diagram showing an example of the raster data of a printing job.

FIG. 7 is a diagram showing an example of output image.

FIG. 8 is a flowchart showing the sequence of the printing control process according to the present invention.

FIG. 9 is a flowchart showing the detail of the raster preparation process in FIG. 8.

FIG. 10 is a flowchart showing the detail of the selection process of the toner to be used in FIG. 8.

FIG. 11 is a flowchart showing the detail of the printing process at the printing unit in FIG. 8.

### DETAILED DESCRIPTION

The preferred embodiments of the invention will be described in detail below with reference to the accompanying drawings.

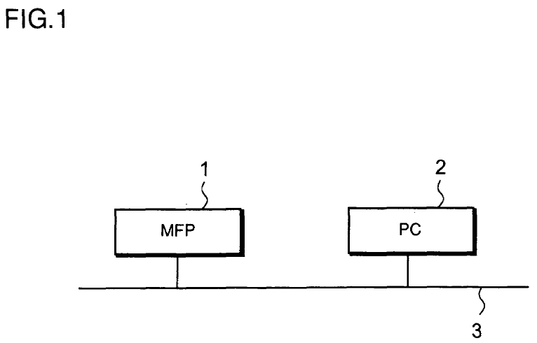

FIG. 1 is a block diagram illustrating the overall structure of a printing system equipped with an image forming apparatus according to an embodiment of the present invention. As shown in FIG. 1, the printing system according to this embodiment is equipped with an MFP 1 as an image forming apparatus and a PC (personal computer) 2 as a printing job transmission device, which are connected via a network 3 to communicate with each other. The types and the number of equipment to be connected to the network 3 are not limited to those shown in FIG. 1. Moreover, the PC 2 can be connected with the MFP 1 directly (local connection) without going through the communication network 3.

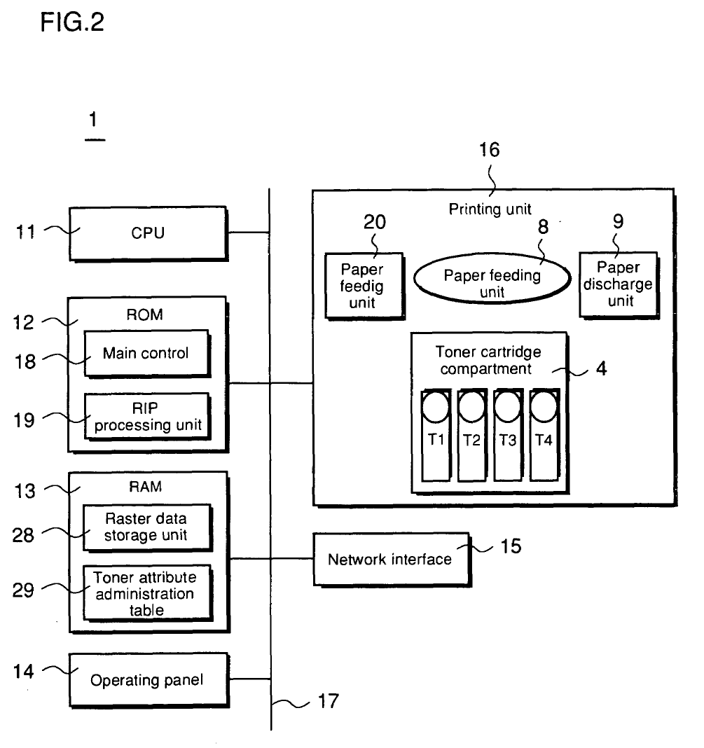

FIG. 2 is a block diagram illustrating the structure of the MFP 1 according to the present embodiment. As shown in FIG. 2, the MFP 1 is equipped with a CPU 11, a ROM 12, a RAM 13, an operating panel 14, and a network interface 15 in a control unit as a printing control unit, as well as a printing unit 16 that forms images by the electrophotographic method, all of which are interconnected by a bus 17 for exchanging signals.

The CPU 11 controls various parts indicated above and executes various arithmetic processes according to a program. The ROM 12 stores various programs and parameters for controlling basic operations of the MFP 1. The RAM 13 stores programs and data temporarily as a working area.

The operating panel 14 is equipped with a touch screen where various kinds of information are displayed, a ten-key pad to be used for setting up the number of copies to be produced and the like, a start key for instructing the start of an operation, a stop key for instructing the stoppage of an operation, a reset key for initializing various setup conditions, etc.

The network interface 15 is an interface for communicating with the PC 2 using standards such as Ethernet, Token Ring, FDDI, etc.

In this embodiment, the ROM 12 stores, as the main control unit 18, conventional processing programs such as the printing process program for printing image data on recording paper as well as the program for determining the order of overlaying toners including CMYK and spot color toners, and the program for the process of printing in accordance with the order of overlaying the toners. It also stores, as a RIP (Raster Image Processing) processing unit 19, a process of developing print data in the PDL (Page Description Language) format received from the PC 2 into image data in the form of bitmap. Moreover, the abovementioned RAM 13 is provided with a raster data storing unit 28 and a toner attribute administration table 29.

On the other hand, the abovementioned printing unit 16 has a paper feeding unit 20, a recording paper transporting unit 8 that enables re-feeding of paper to cause an image to be formed on the same surface, a paper discharge unit 9, and a toner cartridge storage compartment 4. The toner cartridge storage compartment 4 has four cartridge storage compartments T1-T4 each having a cartridge receiving port, and these cartridge storage compartments T1-T4 normally receives toner cartridges of yellow (Y), magenta (M), cyan (C), and black (K) (in the case of the present embodiment, process cartridges 40Y, 40M. 40C, and 40K instead, which will be described later).

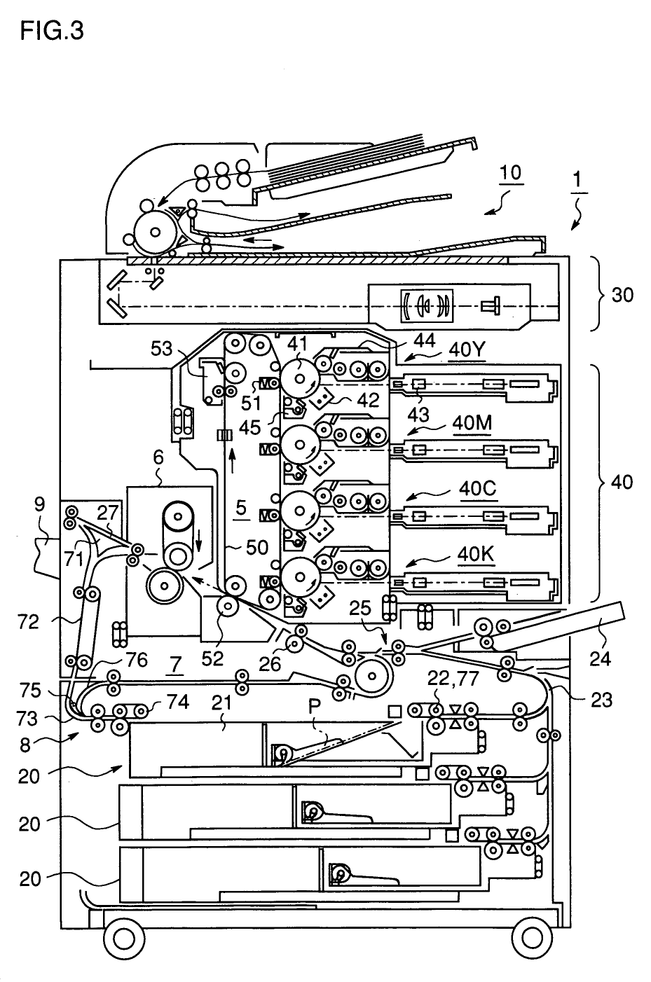

FIG. 3 shows an example of the construction of the MFP 1, which is equipped with the printing unit 16 and the print control unit described above.

The MFP 1 is designed to form an image by the electrophotographic method and has a document feeding unit 10, a paper feeding unit 20, an image forming unit 40 containing the storage compartments for yellow (Y), magenta (M), cyan (C), and black (K) cartridges, an intermediate transfer unit 5 for forming toner images on an intermediate transfer belt 50, which will be described later, a secondary transfer roller 52 for transferring toner images formed on the intermediate transfer belt 50, a cleaning unit 53 for removing and collecting the toner adhered to the intermediate transfer belt 50, a fixing device 6 for melting and then fixing the toner images on the recording paper to be adhered thereto, and a paper discharging unit 9 for discharging the recording paper on which the toner image is fixed to the outside of the printer for storage.

The paper feeding unit 20 consists of three stories, wherein the paper feeding unit of each story having a paper feeding cassette 21 for storing the recording paper, a first paper feeding roller 22 for feeding the recording paper from the paper feeding cassette 21, and a registration roller 26 for controlling the timing for feeding the recording paper upward as shown in the figure from the first paper roller 22. A merging unit 25 is provided in the middle of a transport passage 23 that leads from the first paper feeding roller 22 to the registration roller 26 to cause recording paper from a reversing mechanism 7 and recording paper from a manual feeding unit 24 to merge.

The image forming unit 40 is equipped with Y, M, C, and K process cartridges 40Y, 40M, 40C, and 40K serving as toner cartridges. Each of these process cartridges is equipped with a photosensitive drum 41, a charging unit 42 for charging the photosensitive drum 41, an exposing unit 43 for exposing the charged photosensitive drum 41 with the light generated based on the print data received from the PC2 or the document image scanned by an exposing optical system 30 in order to form an electrostatic latent image on the surface of the photosensitive drum 41, and a developing device 44 for developing this electrostatic latent image with toner. Each photosensitive drum 41 is provided to be able to rotate in the arrow direction shown in the drawing.

The intermediate transfer unit 5 has an intermediate transfer belt 50 wrapped around a driving roller and a driven roller as well as a transfer roller 51 for transferring the toner image formed on the photosensitive drum 41 to the intermediate transfer belt 50. The intermediate transfer belt 50 is being pressed against each photosensitive drum 41 by the transfer roller 51. The secondary transfer roller 52 is provided in such a way as to sandwich the intermediate transfer belt 50 with the driven roller.

Next, the outline of the image forming process of the abovementioned MFP 1 will be described below.

First, the photosensitive drums 41 are evenly charged by the corresponding charging units 42, and are irradiated with the laser beams, which are projected from the print head unit of the corresponding exposing units 43 based on the document image data read out from the PC 2, etc. and then stored in the memory unit. The irradiations with the laser beams form electrostatic latent images on the surfaces of the photosensitive drums 41, which turn into toner images after being supplied with the Y, M, C, and K toner from the developing devices 44 for the process cartridges 40Y, 40M, 40C, and 40K, respectively.

As the intermediate transfer belt 50 rotates in the clockwise direction shown in FIG. 3, the toner image of each color formed on each photosensitive drum surface is transferred (i.e. primary transferring) of the same location of the intermediate transfer belt 50.

On the other hand, the recording paper P stored in the paper feeding cassette 21 is fed out by the first paper feeding roller 22 simultaneously with the scanning of the image data. As the leading edge of the recording paper reaches the registration roller 26, the control unit sends an instruction to feed the recording paper to the registration roller 26 depending on the progress status of the image transfer on the intermediate transfer belt 50. Upon receipt of the instruction, the registration roller 26 feeds out the recording paper to the transfer roller 51.

As the recording paper is transported to the area where it is caught between the transfer roller 51 and the driven roller, the abovementioned toner image, which has been transported with the rotation of the intermediate transfer belt 50, is secondary transferred to the particular recording paper.

The recording paper to which the toner image is transferred is then transported to the fixing device 6 where it is heated and pressed for fixing of the toner image, and subsequently discharged to the paper discharge tray. Such is the sequence of operation during normal printing.

However, in the case of both-sided image forming, the recording paper discharged from the fixing device 6, after having the image formed on one side (i.e. front side), is deviated from a sheet discharge passage 27 at a first bifurcation 71, to be inserted into the rear end of the upper paper feeding cassette 21 for temporary storage within the cassette, via a lower circulating paper passage 73 that constitutes a portion of the reversing mechanism 7. Consequently, this recording paper is placed in the upper paper feeding cassette 21 in the reversed state, i.e., the front face on which the image is formed is facing downward, to wait to be fed again for reversing front to back. The upper paper feeding cassette 21 functions as the intermediate tray for reverse paper feeding. The recording paper is again fed out from this upper paper feeding cassette 21 by means of a second paper feeding roller 74 located at the rear end of the upper paper feeding cassette 21, guided by a second bifurcation 75 to a reversing transport passage 76 to be reversed upside down, and then merged with the transport passage 23 at the junction 25 via a paper re-feeding transport unit 77. After that, printing on the back side is performed as in the conventional printing. The abovementioned units 71-76 constitute the reversing mechanism 7.

Incidentally, the process cartridges of the spot colors which are properly blended for particular applications can be set replacing the Y, M, C, K process cartridges 40Y, 40M, 40C, and 40K, in the abovementioned cartridge storage compartments T1-T4. For this purpose, the process cartridges of the spot colors are designed in the same shape and size as those of the Y, M, C, K process cartridges 40Y, 40M, 40C, and 40K, with only exceptions being that the toners contained inside are those for the spot colors. “Spot colors” herein means colors that are treated as specials comparing to the standard colors, namely C, M, Y, and K. The spot colors include not only the colors that cannot be made from C, M, Y, and K, but also any colors that the user wishes to treat specials comparing to C, M, Y, and K.

The spot colors include metallic colors, such as gold (S1), brand colors (S2) such as thick red, and pastel colors (S3). In the case of spot colors S1, S2, and S3 as well as C, M, Y, and K colors, fair images can be obtained by applying toners in descending order of brightness because of their color and printing properties.

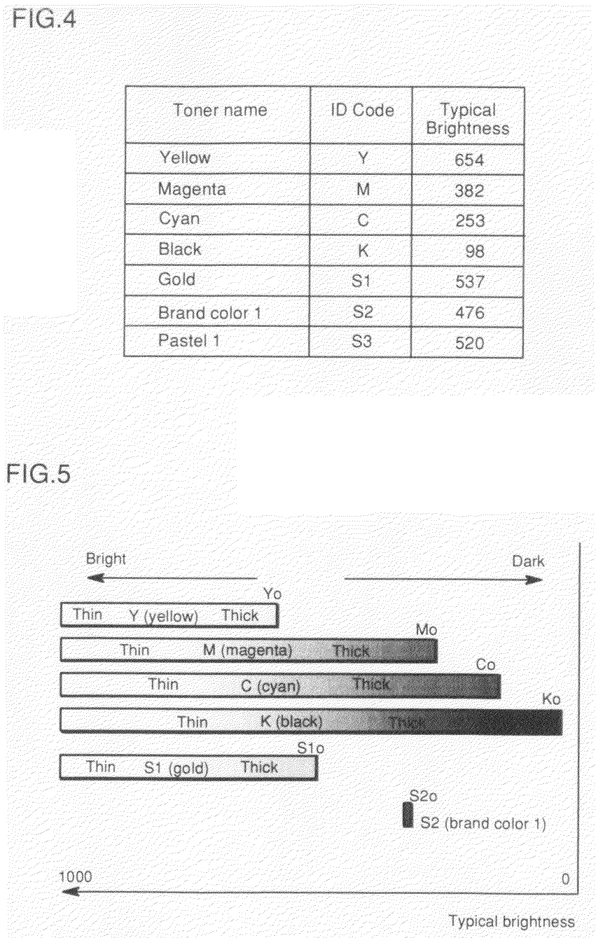

FIG. 4 is an attribute administration table 29 that shows an example of typical brightness of S1, S2, and S3 as well as C, M, Y, and K toner. It can be learnt from the table that the brightness descends in the order of Y, S1, S3, S2, M, C, and K.

The attribute administration table 29 defines, concerning C, M, Y, and K as well as S1, S2, and S3 toners, the name and “typical brightness” specified in accordance with the chemical properties of each toner. Typical brightness herein means a numerical value between 0 and 1000 obtained by converting a measured optical brightness when toner is in 100% solid colored and fixed on paper. The toner name, typical brightness and ID code, predetermined or measured in advance, are administrated per each toner cartridge in the toner attribute administration table 29 shown in FIG. 4.

FIG. 5 is a diagram showing an example of the correlation of typical brightness. FIG. 5 shows an example in the case where two colors, gold (S1) and bland color 1 (S2) consisting of thick red, are used as the spot toners. However, the number of the spot colors is not limited, theoretically speaking. The suffix “o” attached to Y, M, C, K, S1 and S2 in FIG. 5 indicates the location of the area which takes on the typical brightness (i.e. the area taking on the thickest color, in this example), and the typical brightness herein descends in the order of Yo, S1o, S2o, Mo, Co, and Ko.

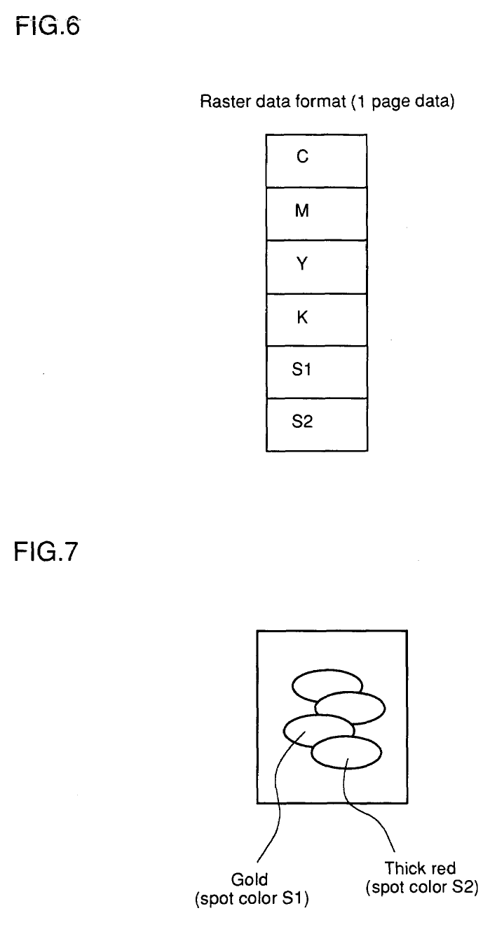

Therefore, as shown in FIG. 6, each object within a PDL printing job includes color designation in the RGB color space, the spot color S1, or the spot color S2, and the object with color designation in the RGB color space is bitmapped into the four planes of Y, M, C, and K; the object with color designation in the spot color S1 is be bitmapped into the plane for the spot color S1; and the object with color designation in the spot color S2 is be bitmapped into the plane for the spot color S2 during the rasterizing process by the RIP processing unit 19. In the actual printing process, by applying toners in the descending order of brightness, i.e., in the order of Y, S1, S2, M, C, and K toners, a better color image can be obtained. FIG. 7 shows a printing output where the spot color S1, i.e., gold, and the spot color S2, i.e., thick red, are applied.

In the present embodiment, as the printing is done using toners in various colors including the four standard colors, Y, M, C, and K as well as two spot colors, images of the remaining two colors (C, K) are further printed over the same plane of the recording paper where the color images of the first four colors (Y, S1, S2, and M) are already printed. As a result, after the recording paper printed with the first four color images is stored temporarily into the intermediate tray, some of the cartridges are replaced with the cartridges for the remaining two colors. Then, the abovementioned recording paper which has been temporarily stored in the intermediate tray, is fed out again from the first paper feeding roller 22 (paper re-feeding unit 77), and the recording paper is again passed through the secondary transfer roller 52 so that the printing is done on the same plane again. Thus, it is made possible to obtain a fair printed image including spot colors, without losing characteristics of the spot colors.

If the number of colors exceeds the maximum number of toner cartridges that can be contained in the toner cartridge storage compartment, the image in the maximum number of colors is printed first, and then the image in the remaining colors is printed over the first printed image. It is hence necessary to feed the paper again in a way that the further printing will be done on the same surface. The detail of this paper re-feeding transport process will be described below.

First, similar to the case of forming an image of both sides, the recording paper after having a toner image in the first four colors (Y, S1, S2, and M) formed and fixed on one surface (front face), is returned to the upper paper feeding cassette 21 to be in a temporary hold state via the first bifurcation 71 and the lower circulating paper passage 73 that constitute the paper re-feeding mechanism. This recording paper is placed in the upper paper feeding cassette 21 in the reversed state, i.e., the front side on which the image is formed is facing downward, to wait to be fed again. The upper paper feeding cassette 21 functions as the intermediate tray for paper re-feeding. Next, the recording paper is sent out from the upper paper feeding cassette 21 by the first paper feeding roller 22 located at the front end of the upper paper feeding cassette 21. The paper feeding operation during the re-feeding thereafter shall be identical to the paper transport in the case of forming an image on one side of the paper under a normal circumstance, i.e., the recording paper is fed to the secondary transfer roller 52 via the transport passage 23, and the toner image in the remaining two colors (C and K) are transferred over the color image in the first four colors (Y, S1, S2, and M). The recording paper on which the toner image is transferred is then transported to the fixing device 6, where it is heated and pressed for fixation of the toner image onto the recording paper, and then discharged to the paper discharge tray. Such is the sequence of operation during spot color printing. In this embodiment, the abovementioned parts 71-73, the paper feeding cassette 21, and the first paper feeding roller 22 (paper re-feeding transport unit 77) constitutes the paper re-feeding mechanism.

The operation of the printing system in this embodiment will be described in the following.

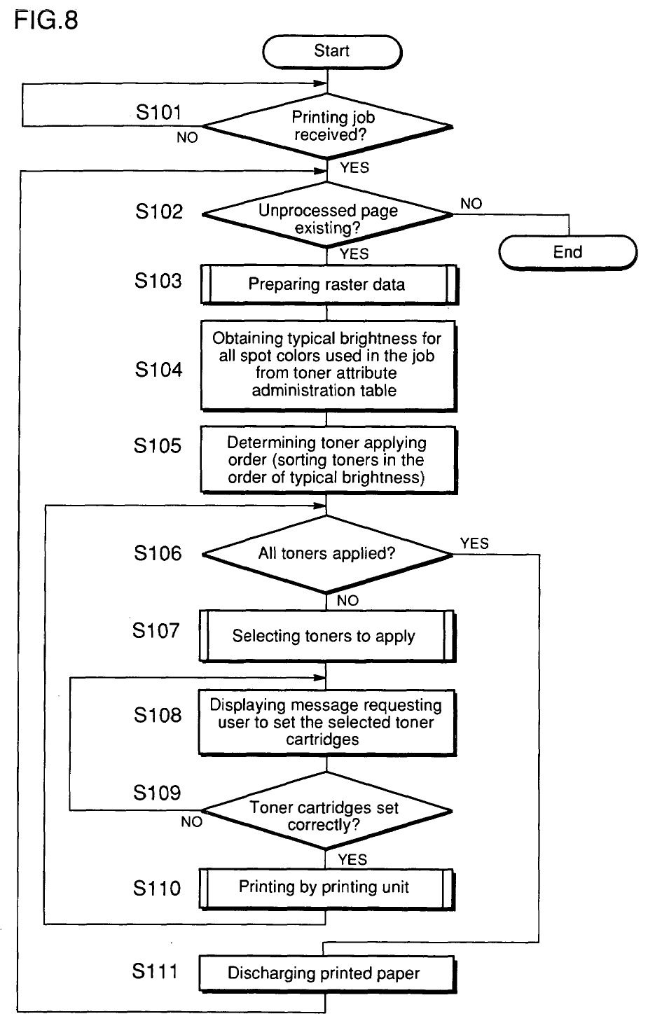

FIG. 8 through FIG. 11 each represents a flowchart showing the printing process of MFP 1 according to this embodiment. The algorithm indicated by the flowchart of FIG. 8 through FIG. 11 is also stored as a control program on the ROM 12 of the MFP 1, read out by RAM 13, and executed by the CPU 11 when the operation starts.

The user prepares a document containing spot colors on the PC 2 and sends it to the MFP 1 of the present apparatus via the network 3 as a printing job.

In FIG. 8, the CPU 11 waits for the printing job to be received (S101). If this printing job does not include any object that requires spot colors, that means the printing job does not contain any information on spot color toners. In contrast, if the printing job includes an object that requires only one of the spot colors S1 and S2, that means the printing job contains information on the toner for either S1 or S2. Similarly, if the printing job includes an object that requires other spot colors S3, S4, etc., that means the printing job contains information on the toners of those spot colors.

Upon receiving a printing job (S101: Yes), the CPU 11 analyses the received printing job requiring spot colors, confirms that there are pages yet to be processed (S102), and then initiates the process of preparing raster data in the multiple colors used for the image of the printing job (S103), after confirming that there are any pages yet to be processed.

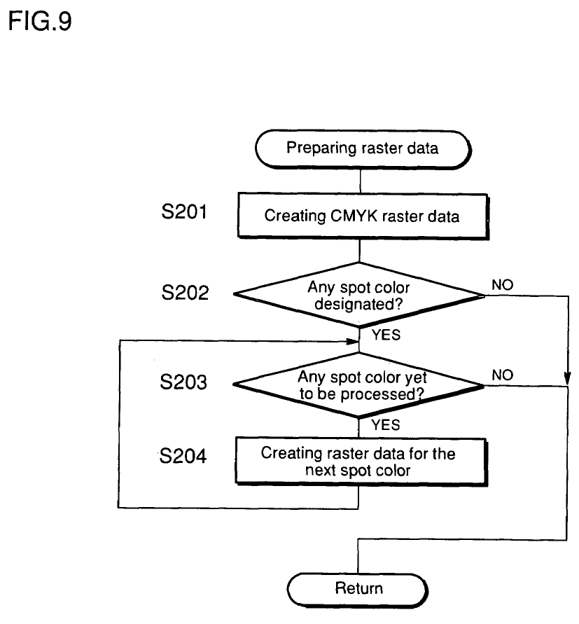

FIG. 9 shows the detail of the process of preparing the raster data. In FIG. 9, the RIP processing unit 19 creates CMYK raster data for an object expressed in the RGB color space (S201), and the CPU 11 stores it to each plane for C, M, Y, and K of the raster data storing unit. Next, the CPU 11 makes a judgment as to whether the object with designation of spot color is included in the printing job, i.e., if there is any designation of spot color, or not (S202). If there is any such designation included in the printing job (S202: Yes), the CPU 11, once confirming that there are still some spot colors to be processed (S203), creates, by the RIP processing means, raster data in spot colors for the object with the designation of the spot colors, in addition to the SMYK raster data as mentioned above, and the stores it to the plane of the relevant spot color in the raster data storing unit (S204). The program then returns to step S203 for repeating the abovementioned steps S203-S204 so long as there is any process for spot colors yet to be processed; that is to say the CPU 11 generates the raster data for the particular spot colors, and stores the raster data of all spot colors to the raster data storing unit. In the present example, the raster data for the spot colors S1 and S2 are prepared, and stored to the planes to which these spot colors correspond respectively.

As the program advances from step S103 to step S104 of FIG. 8, the main control unit 18 refers to the toner attribute administration table 29 (FIG. 4), and seeks typical brightness Co, Mo, Yo, Ko, S1o, and S2o (refer to FIG. 5) for each of CMYK and the spot colors S1, S2 used in the particular job (S104). Next, it sorts out CMYK and S1, S2 in the descending order of typical brightness, and calculates the order of Yo, S1o, S2o, Mo, Co, and Ko to determine it as the order of applying toners for the particular printing job (S105). In the present example, the order of applying toners according to this determination process is Y, S1, S2, M, C and K.

Generally speaking, it is important, for obtaining a fair printing result, to fix CMYK toners in descending order of brightness. Therefore, the calculation of the order of applying toners is based on descending order of typical brightness of each toner. However, if another algorithm is turn out to be more effective in obtaining more fair printing result due to color and printing properties, such an algorithm can be used for determining the order of applying toners.

Next, the main control unit 18, once confirming that all the toners have been applied (S106), initiates the process of selecting the toner to apply (S107).

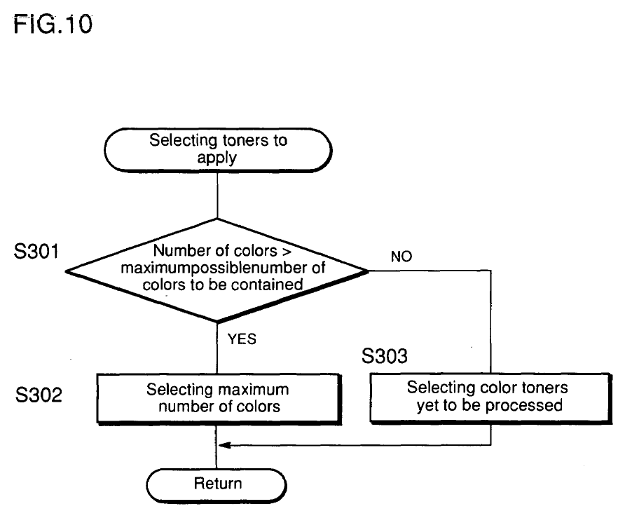

FIG. 10 shows the process of selecting the toner to apply. Since the maximum number of cartridges to be contained in the toner cartridge storage compartment is four (T1-T4) in the MFP described in FIG. 3, it depends whether or not all the toner cartridges for a print image can be handled one time.

First, it is checked whether the number of colors to be used exceeds the maximum number of cartridges to be contained in the toner cartridge storage compartment (S301). If the number of colors to be used exceeds the maximum number of cartridges (S301: Yes), the main control unit 18 selects the first four colors in the determined order, and obtains their toner names from the toner attribute administration table 29 (S302). If the number of the remaining colors is less than four, the main control unit 18 selects these remaining toners, and obtains their toner names from the toner attribute administration table 29 (S303). The program then returns to step S107.

Next, the message prompting the user to store these toner cartridges, i.e., process cartridges, into the cartridge storage compartment T1-T4 is displayed on the operating panel 14 (S108). The operating panel 14 has the responsibility of indicating to the user the correct position of each toner cartridge, and the message includes the notice for replacing the toner cartridge in a specified order. The following is an example of the message:

“Insert the following toner cartridges shown below into T1 through T4 and press OK button:”

T1: yellow,

T2: gold,

T3: brand color 1,

T4: magenta,”

Next, the system waits for the toner cartridges to be properly set by the user (S108-S109). Each toner cartridge is normally provided with computer-readable information on toner attribute such as color, and a reading unit is equipped with the cartridge storage compartment T1-T4 for reading the toner attribute information of each toner. Therefore, the CPU 11 is capable of grasping which toner cartridge is set in which one of the cartridge storage compartments T1-T4 from the toner attribute information of each cartridge, and identification information of each cartridge storage compartment T1-T4.

Once detecting the fact that a user has set the toner cartridges in accordance with the message (S109: Yes), the program advances to the printing process by the printing unit 16 (S110). The main control unit 18 feeds the recording paper from the paper feeding unit 20 of the printing unit 16, and sequentially outputs video signals representing raster data in each of the first four colors in the order of applying toners as mentioned above (Y, S1, S2 and M), to the printing unit 16.

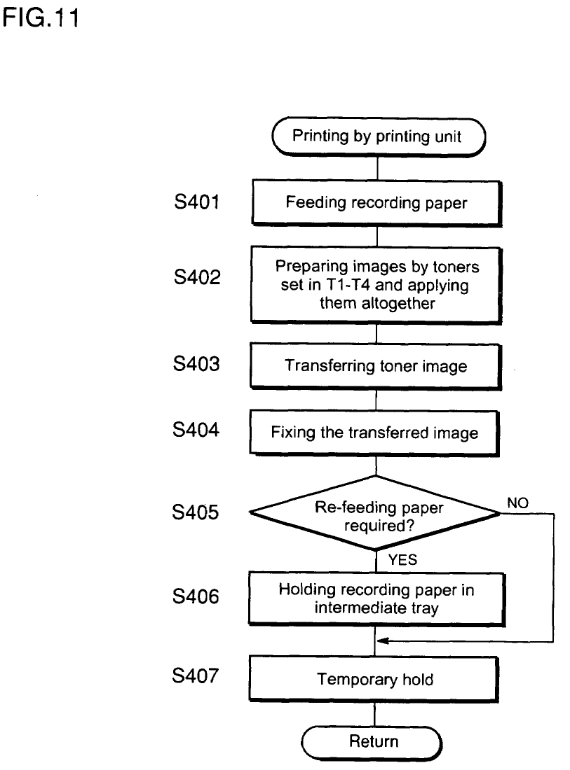

FIG. 11 shows the detail of this printing process by the printing unit. The printing unit 16 supplies the recording paper (S401), and forms a toner image in the four colors on the intermediate transfer-printing belt 50 (S402), by sequentially applying each of the toner cartridges set in the cartridge storage compartment T1-T4 based on the video signals representing the raster data in the four colors. The formed toner image is transferred to the recording paper (S403), and then fixed (S404). This completes the color printing on one side of the recording paper. Incidentally, the order of applying toners to the intermediate transfer-printing belt 50 is the same as the ascending order of brightness (M, S2, S1 and Y), and therefore the order of toners transferred to the recording paper turns out to be the same as the descending order brightness (Y, S1, S2 and M).

Next, a judgment is made as to whether it is necessary to re-feed paper by the paper re-feeding mechanism consisting of the constituting members 71-73, the paper feeding cassette 21, and the first paper feeding roller 22 of the abovementioned MFP 1 (S405), and, if it is judged as necessary (S405: Yes), the recording paper is transported to the intermediate tray of the paper re-feeding mechanism (upper paper feeding cassette 21) to be stored (S406). When the single side printing is executed for a plurality of sheets in a row, the plurality of sheets of recording paper will be stacked in the intermediate tray (S406). The printing unit 16 is then brought to a temporary stop (S407). The program returns to step 110 of FIG. 8.

The program further advances from step S110 to step S106 in FIG. 8.

At this point, the printing process has only been done for the four colors out of six in total. Therefore, the judgment as to whether all the toners have been applied in step S106 turns out to be “No,” and the program advances to step S107 to invoke the process of selecting the toner to apply in FIG. 10.

In the process of selecting the toners to apply in FIG. 10, a judgment is made again as to whether or not the number of the remaining colors exceeds the maximum possible number of cartridges to be contained in the cartridge storage compartments T1-T4 (S301)

If the number of the remaining colors is larger than the maximum number (S301: Yes), the program returns to step S107 via the abovementioned step S302. In this example of the color printing in the six colors, i.e., CMYK as well as S1 and S2, it follows that there are two remaining colors. Because of the fact that the number of remaining colors is less than the maximum number of cartridges to be contained in the cartridge storage compartments, the judgment result in step S301 turns out to be “No.” Therefore, the main control unit 18 selects the remaining two colors (C and K) in accordance with the determined order of applying toners, and obtains the toner name or each of those two colors from the toner attribute administration table 29 (S303). The program returns to step S107 of FIG. 8.

The program advances from step S107 to S108 of FIG. 8, and the main control unit 18 displays a message on the operating panel 14 to prompt the user to store the selected color toners, i.e., toner cartridges, into the proper setting position of the cartridge storage compartments T1-T4, i.e., to replace the toner cartridges (S108). This message also includes the notice of replacing the toner cartridges in the proper order for forming the image in the remaining two colors (C and K). The following is an example of the message.

“Insert the following toner cartridges shown below into T1 through T4 and press OK button:”

T1: cyan,

T2: black”

The main control unit waits for the cartridges of the remaining two colors (C and K) to be properly set (S109). Once it is confirmed that the cartridges of the remaining two colors are properly set in accordance with the message (S109: Yes), the main control unit 18 initiates the printing process (S110) to execute the image printing in C and K.

More specifically, the first paper feed roller 22 serving as the paper re-feeding transport unit 77 in the paper re-feeding mechanism feeds the abovementioned recording paper which has had a toner image printed on its one side and then has been stored in the intermediate tray (upper paper feeding cassette 21) of the printing unit 16 (S401). Meanwhile, video signals representing the raster data for the two color portions (C and K) are sequentially outputted to the printing unit 16 in accordance with the order of applying toners. The printing unit 16 forms a toner images in the colors (C and M) on the transfer-printing belt (S402), by sequentially applying each of the toner cartridges set in the cartridge storage compartments T1-T2 in the order of K and C, based on the received signals representing these two colors, transfer the formed toner image to the recording paper, by the secondary transfer-printing roller 52, in a way that the toners are transferred in the order of C and K, and then fixes the transferred image by the fixing device 6 (S403, S404). This completes the color printing of the first page in all six colors.

Once the color printing complete, it is judged in steps S405 that re-feeding of the recording paper is no more necessary for this particular page (S405: No), the CPU 11 is brought to a temporary, and then returns to step S106 of FIG. 8. Since the printing in all the colors is finished, the judgment in step S106 turns out to be “Yes,” and the finished recording paper is discharged from the paper discharging unit 9 (S111).

The CUP11 then returns to step S102 to make a judgment as to whether there are any pages yet to be processed, and the abovementioned steps S102-S111 are repeated page by page, if any, before finishing the whole process (S102: No).

Thus, high quality color printing can be achieved for an image including spot colors, by applying spot and regular colors in the descending order of brightness. This effect is particularly conspicuous in expressing gradation including spot colors.

While the sequence of events from the printing process to the toner replacement is executed twice considering the maximum number of toner cartridges that can be contained in the toner cartridge storage compartments in the present example, it is possible to execute the sequence more than twice in order to print in more colors. The above printing process is unique in that spot colors are not handled separately from CMYK colors, but rather handled in the same manner as CMYK. The process enables a user to determine the order of overlaying toners simply by sorting all colors including CMYK and spot colors in accordance with their brightness values. The present invention can be applied even in the case of printing in three colors of CMY or two colors of CM, as well as in the case of the combination of CMY or CM and spot colors, allowing for as fair color printing as the user intends.

As it is possible to control the order of applying spot colors and regular colors as shown in the above, high quality color printing of an image including spot colors can be achieved.

As can be seen from the above, it is made possible by the present embodiment, to control the order of overlaying toners in a plurality of colors effectively, in order to obtain as fair images as designers' intend due to the printing properties of the toners. The invention allow for conspicuous effects in printing an images including gradation in spot colors.

It is also made possible by the present embodiment to print an excellent image including spot colors by simply replacing CMYK toner cartridges set in a existing cartridge storage compartment with spot color toner cartridges. Furthermore, the number of spot colors to be used can be arbitrarily increased if necessary. Therefore, there is no need either to add a special mechanism for containing spot color toner cartridges, or any special structure for developing an images in particular spot colors, to an existing image forming apparatus, and therefore excellent printing results can be achieved easily and economically.

The units and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network 3 such as the Internet. In this case, the program recorded on the computer readable recording medium is ordinarily transferred to and stored in a memory unit such as a hard disk. Said program can also be provided as independent application software or can be built into the software of the image processing device as a part of its function.

The invention is not limited to the embodiment described above, but also can be changed in various ways within the scope of the claims.

For example, even though the order of applying various color toners is determined by the MFP 1 in the abovementioned embodiment, the present invention is not limited to this. For example, it is possible for the CPU 2 to determine the order of overlaying toners based on information on the order of applying toners that is included in the printing job beforehand.

Also, the order of applying toners can also be specified by a user operating the operating panel 14 of the MFP 1 or the PC 2. Such a method allows a designer of an image to change the order of applying toners on his own, thus allowing him to achieve such a fair printing output in color satisfaction.

In the aforementioned example, for completing a print image on one side of the printing paper in multiple cycles, the transporting unit with the re-feeding function transports the recording paper so that it is inserted through the rear end of the intermediate tray for a temporary storage and then re-fed through the front end of the intermediate tray at the right moment. However, the present invention is not limited to it. For example, if the image forming apparatus such as MFP 1 and a printer is equipped with a reversing mechanism for reversing front and back sides of the recording paper, it is possible to transport the recording paper to the print engine again in a way that the same side of the recording paper is submitted to the printing, by driving the recording paper through the reversing mechanism twice.

Moreover, the structures for completing a print image in multiple cycles on one side of the recording paper, does not always have to be placed in one single cabinet. For example, it is possible to have two printers to be used for the first and second cycles respectively.

Also, it is possible to use other devices such as dedicated terminal equipment in place of the PC 2 as the printing job transmission device. Furthermore, other devices such as a copying machine or a printer, in place of the MFP 1, can be used as an image forming apparatus.

What is claimed is:

1. An image forming apparatus, comprising:
a determining unit that analyses data concerning an image to be printed and determines the order of overlaying toners in a plurality of colors to be used for the particular image; and
a designating unit that designates positions of the toner cartridges based on the order of overlaying the toners determined by said determining unit.

2. The image forming apparatus as claimed in claim 1, wherein
the toners for said plurality of colors to be used for printing the image includes two or more of toners for (1) the standard colors, i.e., C (cyan), M (magenta), Y (yellow), and K (black), and (2) at least one spot color.

3. The image forming apparatus as claimed in claim 1, wherein
said determining unit determines the order of overlaying the toners in accordance with descending order of brightness of the toners.

4. The image forming apparatus as claimed in claim 1, wherein
said determining unit determines the order of overlaying the toners in accordance with users' specification.

5. The image forming apparatus as claimed in claim 1, further comprising:
a notifying unit that notifies users, in the case where the number of colors to be used exceeds the maximum number of toner cartridges that can be contained in a toner cartridge storage compartment in the case where the number of colors to be used exceeds the maximum number of toner cartridges that can be contained in a toner cartridge storage compartment, that used toner cartridges should be replaced with toner cartridges after the image formation in the same number of colors as said maximum number, for the image formation in the remaining colors, in accordance with the order of overlaying the toners determined by said determining unit.

6. An image forming method, comprising the steps of:
1) analyzing data concerning an image to be printed and determining the order of overlaying toners in a plurality of colors to be used for the particular image; and
2) designating positions of the toner cartridges based on the order of overlaying the toners determined in said step 1).

7. The image forming method as claimed in claim 6, wherein
the toners for said plurality of color toners to be used for printing the image includes two or more of toners for (1) the standard colors, i.e., C (cyan), M (magenta), Y (yellow), and K (black), and (2) at least one spot color.

8. The image forming method as claimed in claim 6, wherein
in said step 1), the order of overlaying the toners is determined in accordance with descending order of brightness of the color toners.

9. The image forming method as claimed in claim 6, wherein
in said step 1), the overlaying order of the toners is determined in accordance with users' specification.

10. The image forming method as claimed in claim 6 further comprising the step of:
3) notifying users, in the case where the number of colors to be used exceeds the maximum number of cartridges that can be contained in a toner cartridge storage compartment, that used toner cartridges should be replaced with toner cartridges after the image formation in the same number of colors as said maximum number, for the image formation in the remaining colors, in accordance with the order of overlaying the toners determined in said step 1).

11. A computer readable recording medium stored with a program for controlling an image forming apparatus, said program causing a computer to execute the steps of:
1) analyzing data concerning an image to be printed and determining the order of overlaying toners in a plurality of colors to be used for the particular image; and
2) designating positions of the toner cartridges based on the order of overlaying the toners determined in said step 1).

12. The computer readable recording medium as claimed in claim 11, wherein
the toners for said plurality of colors to be used for printing the image includes two or more of toners for (1) the standard colors, i.e., C (cyan), M (magenta), Y (yellow), and K (black), and (2) at least one spot color.

13. The computer readable recording medium as claimed in claim 11, wherein
in said procedure 1), the order of applying the toners is determined in accordance with descending order of brightness of the toners.

14. The computer readable recording medium as claimed in claim 11, where
in said procedure 1), the order of overlaying the toners is determined in accordance with users' specification.

15. The computer readable recording medium as claimed in claim 11 further comprising the step of:
3) notifying users, in the case where the number of colors to be used exceeds the maximum number of the cartridges that can be contained in a toner cartridge storage compartment, that used toner cartridges should be replaced with toner cartridges after the image formation in the same number of colors as said maximum number, for the image formation in the remaining colors, in accordance with the order of overlaying the toners determined in said step 1).
